(19) United States
(12) Patent Application Publication
(10) Pub. No.: US 2013/0156514 A1
(43) Pub. Date: Jun. 20, 2013

(54) PUSH BROACH

(71) Applicants: Hong Fu Jin Precision Industry (ShenZhen) Co., Ltd., Shenzhen (CN); HON HAI PRECISION INDUSTRY CO., LTD., New Taipei (TW)

(72) Inventor: WEN-WU XU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/707,943

(22) Filed: Dec. 7, 2012

(30) Foreign Application Priority Data
Dec. 14, 2011 (CN) 201110417509.2

(51) Int. Cl. B23D 43/02

(52) U.S. Cl. CPC B23D 43/02
USPC 407/18; 407/13

(57) ABSTRACT

A push broach, for machining a quadrilateral hole or quadrilateral groove, includes a shank portion and a cutting portion connected to the shank portion. The cutting portion includes at least one pair of cutting teeth including a first cutting tooth and a second cutting tooth arranged substantially parallel to the first cutting tooth, the first cutting tooth includes a pair of first cutting edges at two opposite edges thereof, the second cutting tooth includes a pair of cutting edges at two opposite edges thereof, when viewed from an end of the shank portion, each second cutting edge interconnects the pair of first cutting edge, and the pair of the first cutting edges and the pair of second cutting edges cooperatively form a quadrangle enclosing a periphery of the first cutting tooth.

### BACKGROUND

1. Technical Field

The present disclosure relates to a cutter, and particularly to a push broach.

2. Description of Related Art

A push broach is used to machine a pre-machined hole on articles. The push broach includes a plurality of cutting teeth uniformly spaced from each other along an axis thereof. Each cutting tooth includes a plurality of cutting edges around a periphery thereof. The plurality of cutting edges of the plurality of cutting teeth is overlapped in an end view. A push broach with a smaller outline size is needed to fabricate a housing of a small electronic device. However, it is difficult to machine the plurality of cutting edges of a smaller sized push broach.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an diagram view of a metallic workpiece with a pre-machine hole.

FIG. 2 is an isometric view of an embodiment of a push broach.

FIG. 3 is an enlarged view of a circled portion III-III of the push broach of FIG. 2.

### DETAILED DESCRIPTION

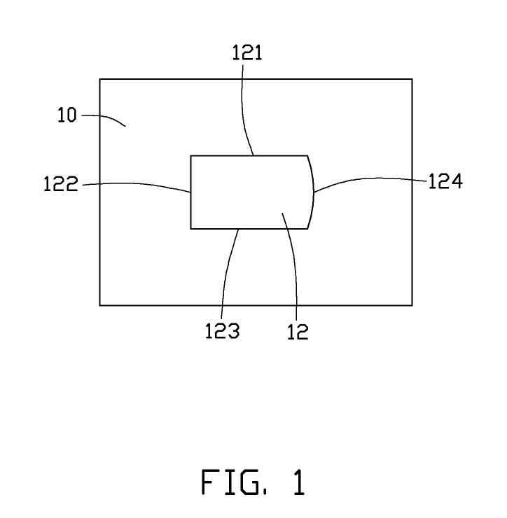

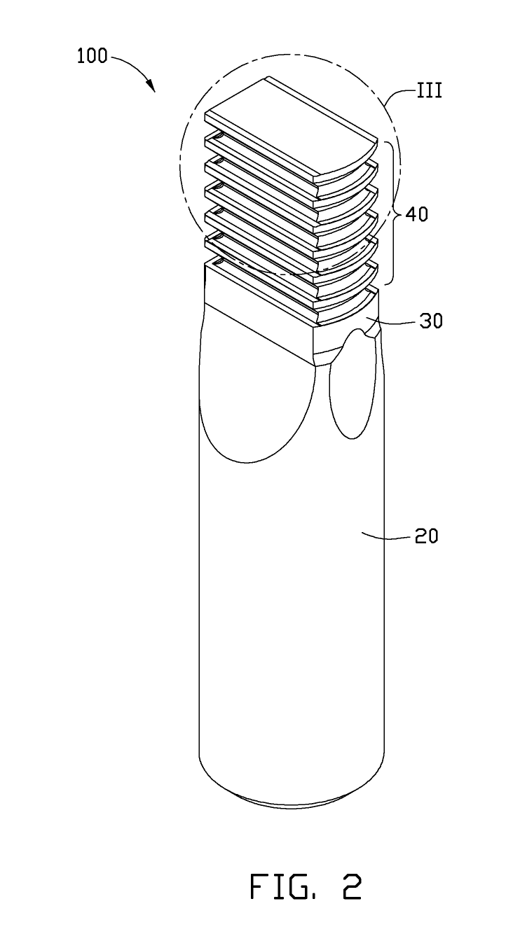

FIGS. 1 and 2 show an embodiment of a push broach 100 employed to finely machine a pre-machined hole 12 in a metallic workpiece 10. The pre-machined hole 12 is a rough quadrilateral hole with a lateral size smaller than the lateral size of the push broach 100. The push broach 100 finely machines the pre-machined hole 12 and removes a finishing allowance of the pre-machined hole 12, and thereby a metallic workpiece 10 with a hole having a predetermined shape and size, and a smooth appearance is obtained. In an illustrated embodiment, the metallic workpiece 100 is made of aluminum alloy. However, the metallic workpiece 10 can be made of other metallic alloys, such as magnesium alloy, zinc alloy, and stainless steel.

The pre-machined hole 12 is substantially rectangular, and includes three straight edges 121, 122, 123 and a curved edge 124 connected to each other in an end to end manner. The push broach 100 is substantially a rod shape, and is made of high speed steel. The push broach 100 can be a cutting assembly made of hard alloy. The push broach 100 includes a shank portion 20, a calibration portion 30, and a cutting portion 40 connected to each other in that order. The pre-machined hole 12 can be a rectangular groove, a polygonal hole, or a polygonal groove.

The shank portion 20 is used for transmitting a dynamic force created by a machine to the cutting portion 40. A cross-section of the shank portion 20 is substantially circular. The cross-section of the shank portion 20 can be a rectangular shape or other shapes. The calibration portion 30 interconnects the shank portion 20 and the cutting portion 40, and is used to smooth an inner periphery surface of the pre-machined hole 12 and amend a lateral size of the pre-machined hole 12. A cross-section of the calibration portion 30 is substantially rectangular. A shape and size of the cross-section are substantially the same as the shape and size of the pre-machined hole 12. If the cutting portion 40 is abraded by accident, the calibration portion 30 is employed to machine the pre-machined hole 12.

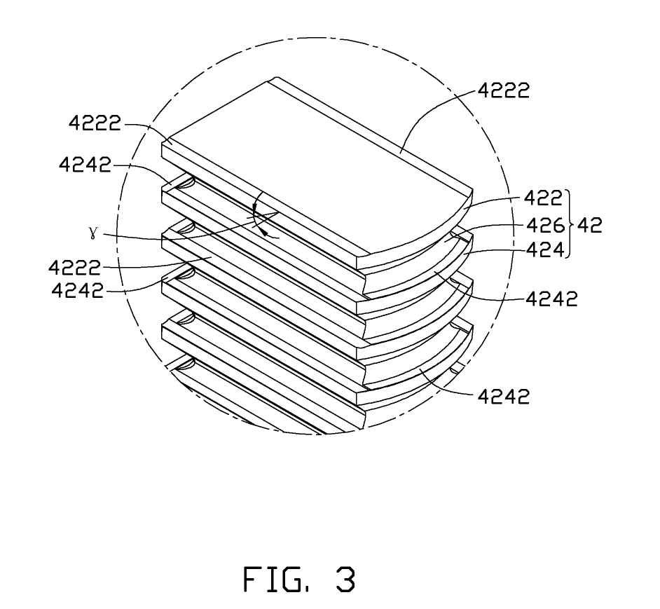

Also referring to FIG. 3, the cutting portion 40 is used for finely machining the pre-machined hole 12. The cutting portion 40 includes at least one pair of cutting teeth 42. In the illustrated embodiment, the cutting portion 40 includes three pairs of cutting teeth 42 arranged substantially parallel to each other along an axis of the shank portion 20. Lateral sizes of the three pairs of cutting teeth 42 decrease along a direction away from the calibration portion 30. That is, the lateral size of the pair of cutting teeth 42 on a free end of the cutting portion 40 is slightly smaller than the lateral size of the pre-machine hole 12, and the lateral size of the cutting teeth 42 adjacent to the calibration portion 30 is substantially equal to the lateral size of the pre-machine hole 12. Each pair of cutting teeth 42 includes a first cutting tooth 422 and a second cutting tooth 424 arranged substantially parallel to each other along the axis of the shank portion 20. The cutting portion 40 defines a plurality of chip grooves 426 around a periphery thereof between the two pairs of cutting teeth 42 adjacent to each other, and also between the first cutting tooth 422 and the second cutting tooth 424 of a same pair of cutting teeth 42.

The first cutting tooth 422 is substantially a rectangle shape similar to the pre-machined hole 12. The first cutting tooth 422 includes a pair of first cutting edges 4222 along a periphery thereof. The pair of cutting edges 4222 is opposite to each other, and each cutting edge 4222 is located on a straight edge of the first cutting tooth 422. In the embodiment, each first cutting edge 4222 defines a front angle γ, which is formed by grinding with a grinding wheel.

The second cutting tooth 424 is a rectangular shape similar to the first cutting tooth 422. The second cutting tooth 424 includes a pair of second cutting edge 4242 along a periphery thereof. The pair of second cutting edges 4242 is opposite to each other, and one second cutting edge 4242 is located at a curved edge of the second cutting tooth 424 corresponding to the curved edge 124 of the pre-machined hole 12. The other second cutting edge 4242 is located at a straight edge opposite to the curved edge of the second cutting tooth 424. Each second cutting edge 4242 defines a front angle γ thereon. The pair of second cutting edges 4242 of the second cutting tooth 424 is substantially perpendicular to the pair of first cutting edges 4222 of the first cutting tooth 422, the pair of second cutting edges 4242 and the pair of first cutting edges 4222 cooperatively enclose a periphery of the first cutting tooth 422 when viewed from an end of the shank portion 20.

The shape of the cutting teeth 42 can be changed according to the shape of the pre-machined hole 12. If the pre-machined hole 12 is rectangular, the first cutting tooth 422 and the second cutting tooth 424 are rectangular; and the pair of second cutting edges 4242 is located on straight edges. Ends of each first cutting edge 4222 and each second cutting edge 4242 can be chamfered when a pre-machine hole 12 with an arc-corner is to be machined.

The first cutting edge 4222 and the second cutting edge 4242 can be coated with a wear-resistant layer to prolong its useful life. The wear-resistant layer can be made of boron nitride, silicon nitride, aluminium nitride, diamond, or diamond-like material. The calibration portion 30 can be omitted, and the cutting portion 40 is directly connected to the shank portion 20.

When in use, the push broach 100 is mounted on a machine (not shown), the metallic workpiece 10 is fixed to a worktable (not shown), and then the push broach 100 is pushed by the machine to finely machine the pre-machined hole 12 of the workpiece 10. The pair of first cutting edges 4222 of the first cutting teeth 422 enters into the pre-machined hole 12 first, and machines two opposite straight edges 121, 123 of the pre-machined hole 12. The pair of second cutting edges 4242 then enters into the pre-machine holed 12 and machines the other two opposite edges 122, 124 of the pre-machine holed 12. The three pair of cutting teeth 42 enters into and machines the pre-machine holed 12 in turn. Finally, the calibration portion 30 enters into the pre-machined hole 12 and smoothes a periphery sidewall of the pre-machined hole 12. Thus, the fine machining process of the pre-machined hole 12 of the metallic workpiece 10 is accomplished.

The first cutting tooth 422 and the second cutting tooth 424 are spaced from each other, and the pair of first cutting edges 4222 and the pair of second cutting edges 424 are substantially perpendicular to each other. Furthermore, the pair of first cutting edges 4222 and the pair of second cutting edges 424 are located on the first cutting tooth 422 and the second cutting toot 424 respectively. Therefore, in the fabricating process of the push broach 100, an interference between the pair of first cutting edges 422 and the pair of second cutting edges 4242 can be eliminated, and the cost thereof is reduced.

The first cutting tooth 422 and the second cutting tooth 424 can be other polygon shapes, such as a pentagon shape. The first cutting tooth 422 and the second cutting tooth 424 can include a plurality of cutting edges, with the first cutting edges 4222 and the second cutting edges 4242 spaced from each other and respectively located on the first cutting tooth 422 and the second cutting tooth 424.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A push broach, for machining a quadrilateral hole or a quadrilateral groove, the push broach comprising a shank portion and a cutting portion connected to the shank portion, wherein the cutting portion comprises at least one pair of cutting teeth comprising a first cutting tooth and a second cutting tooth arranged substantially parallel to the first cutting tooth, the first cutting tooth comprises a pair of first cutting edges at two opposite edges thereof, the second cutting tooth comprises a pair of second cutting edges at two opposite edges thereof, when viewed from an end of the shank portion, each second cutting edges interconnects the pair of first cutting edges, and the pair of the first cutting edges and the pair of second cutting edges cooperatively form a quadrangle enclosing a periphery of the first cutting tooth.

2. The push broach of claim 1, wherein the cutting portion defines a chip groove around a periphery thereof between the first cutting tooth and the second cutting tooth.

3. The push broach of claim 1, wherein the at least one pair of cutting teeth comprises three pair of cutting teeth arranged substantially parallel to each other along an axis of the shank portion, and the cutting portion further defines the chip groove around a periphery thereof between every two pair of cutting teeth.

4. The push broach of claim 1, wherein the at least one cutting teeth comprises three cutting teeth arranged substantially parallel to each other along an axis of the shank portion, and lateral sizes of the three pair of cutting teeth decrease along a direction away from the shank portion.

5. The push broach of claim 1, wherein one or both of the first cutting edge and the second cutting edge define a front angle thereon.

6. The push broach of claim 1, wherein one or both of the first cutting edge and the second cutting edge are chamfered at two opposite ends.

7. The push broach of claim 1, wherein one or both of the first cutting edge and the second cutting edge are coated by a wear-resistant layer.

8. The push broach of claim 7, wherein the wear-resistant layer is made of boron nitride, silicon nitride, aluminium nitride, diamond, or diamond-like material.

9. The push broach of claim 1, wherein one or both of the first cutting edge and the second cutting edge has a curved outline shape.

10. The push broach of claim 1, wherein the push broach further comprises a calibration portion interconnecting the shank portion and the cutting portion, and a lateral size of the calibration portion is substantially equal to that of the quadrilateral hole or quadrilateral groove.

11. A push broach, for machining a polygon hole or a polygon groove, the push broach comprising a shank portion, and a cutting portion connected to the shank portion, wherein the cutting portion comprises at least one pair of cutting teeth comprising a first cutting tooth and a second cutting tooth arranged substantially parallel to the first cutting tooth, the first cutting tooth comprises at leas one first cutting edge along a periphery thereof, the second cutting tooth comprises at leas one second cutting edge along a periphery thereof, when viewed from an end of the shank portion, the at least one first cutting edge connects with the at least one second cutting edge, and the at least one first cutting edge and the at least one second cutting edge cooperatively enclose the periphery of the first cutting tooth.

12. The push broach of claim 11, wherein the cutting portion defines a chip groove around a periphery thereof between the first cutting tooth and the second cutting tooth.

13. The push broach of claim 11, wherein the at least one pair of cutting teeth comprises three pairs of cutting teeth arranged substantially parallel to each other along an axis of the shank portion, and the cutting portion further defines the chip groove around a periphery thereof between every two pair of cutting teeth.

14. The push broach of claim 11, wherein the at least one pair of cutting teeth comprises three pair of cutting teeth arranged substantially parallel to each other along an axis of the shank portion, and lateral sizes of the three pair of cutting teeth decrease along a direction away from the shank portion.

15. The push broach of claim 11, wherein one or both of the at least one first cutting edge and the at least one second cutting edge define a front angle thereon.

16. The push broach of claim 11, wherein one or both of the at least one first cutting edge and the at least one second cutting edge are chamfered at two opposite ends.

17. The push broach of claim 11, wherein one or both of the at least one first cutting edge and the at least one second cutting edge are coated by a wear-resistant layer.

18. The push broach of claim 17, wherein the wear-resistant layer is made of boron nitride, silicon nitride, aluminium nitride, diamond, or diamond-like material.

19. The push broach of claim 11, wherein one or both of the at least one first cutting edge and the at least one second cutting edge has a curved outline shape.

20. The push broach of claim 11, wherein the push broach further comprises a calibration portion interconnecting the shank portion and the cutting portion, and a lateral size of the calibration portion is substantially equal to that of the quadrilateral hole or quadrilateral groove.
